(19) United States
(12) Patent Application Publication
(10) Pub. No.: US 2005/0229100 A1
(43) Pub. Date: Oct. 13, 2005

(54) Creating linked electronic documents

(76) Inventor: Aurobinda Pradhan, Bangalore (IN)

Correspondence Address: FISH & RICHARDSON, P.C., PO BOX 1022, MINNEAPOLIS, MN, 55440-1022, US

(21) Appl. No.: 10/820,685

(22) Filed: Apr. 8, 2004

(51) Int. Cl. G06F 17/21

(52) U.S. Cl. 715/530; 715/513; 715/501.1

(57) ABSTRACT

In a method of creating an electronic document that is linked to another electronic document, a view of a selected electronic document is displayed on a graphical user interface. While the view of the selected electronic document is being displayed, a predetermined user input to create a new electronic document is received. The new electronic document is created in response to receiving the predetermined user input, wherein the selected electronic document and the new electronic document are linked to each other.

### TECHNICAL FIELD

This description relates to creating an electronic document that is linked to another electronic document.

### BACKGROUND

Most of today's computer systems are capable of storing and displaying a great number of electronic documents. These documents are typically stored as separate files and may belong to any of several categories, such as documents for word processing programs, scanned documents, images, electronic forms, spreadsheets, and so on. Usually, a specific application program is designated for handling each separate category of documents, such as word processing programs for text documents and imaging programs for images and graphics.

From a user's perspective, several different documents may relate to a common subject. These may be documents of the same or different file types. Because of the relation between the documents, the user may need to review or edit more than one of these documents at any given time. Thus, it would be helpful to user if the documents were organized in the computer system so that the user can easily find the documents that are related to each other.

Organization of documents in computer systems is largely based on a system of directories. For example, the Windows operating system from Microsoft lets a user store documents (and other files) in file folders that can be given unique names, and folders can be stored within folders to create a hierarchy. In this way, the user can arrange the files stored in the computer's hard drive such that files relating to different subjects are grouped together in specific folders. A user can store a document in a specific folder using a specific “save” function in the application program to which the document belongs (such as a word processing program). Operating systems typically let users move stored documents between existing folders on the computer without opening any application program(s) to which they belong.

Other document management programs also exist. One example of such a program is the ProLaw document management program available from ProLaw Software in Albuquerque, N. Mex. ProLaw lets the user create a “Matter ID” for collecting all documents that relate to a specific subject. ProLaw has a graphical user interface that lets the user create new documents that should be associated with a selected Matter ID. ProLaw can display a list of all the documents that are associated with a selected Matter ID such that the user can choose to open any of the documents by clicking on them.

One disadvantage with the above-described systems may be that document creation is essentially independent of any currently displayed document. It may therefore be relatively difficult for a user to establish an association between a new document and an open document, In systems using file-folder hierarchies, a user can create a new document in the application program that is currently displaying a document and then—by means of dialog boxes appearing on the screen—save the document in the same folder as the displayed document. In ProLaw, by contrast, the new document must be created in the ProLaw graphical user interface—or be “dragged” into it after creation—to be associated with the same Matter ID as the displayed document. Moreover, the association between the newly created document and the displayed document in these systems, once created, is relatively weak. Neither of them offers a convenient navigation from a selected document to related documents that were created while the selected document was being displayed. Accordingly, these systems do not provide a convenient function for creating an electronic document that is associated with another electronic document.

### SUMMARY

The invention relates to creating an electronic document that is linked to another electronic document. In a first general aspect, a method comprises displaying a view of a selected electronic document on a graphical user interface. While the view of the selected electronic document is being displayed, a predetermined user input to create a new electronic document is received. The new electronic document is created in response to receiving the predetermined user input, wherein the selected electronic document and the new electronic document are linked to each other.

In selected embodiments, the predetermined user input may specify that the new electronic document is a follow-up of the selected electronic document.

In selected embodiments, an identifier is stored in association with at least one of the selected electronic document and the new electronic document to link them to each other. The identifier may be used, while a view of the new electronic document is being displayed, to provide access to the selected electronic document. The identifier may be used, while the view of the selected electronic document is being displayed, to provide access to the new electronic document. A determination may be made, in response to receiving the predetermined user input, that the view of the selected electronic document is being displayed, and the identifier may be generated based on the determination.

In selected embodiments, a first identifier may be stored in association with the selected electronic document and a second identifier may be stored in association with the new electronic document to link them to each other. The selected electronic document may be linked also to at least one other electronic document and a third identifier may be stored in association with the selected electronic document to link them to each other.

In a second general aspect, a graphical user interface for creating an electronic document that is linked to another electronic document comprises a document display area wherein a view of a selected electronic document can be displayed, and a user-selectable input control that creates a new electronic document while the view of the selected electronic document is being displayed, wherein the selected electronic document and the new electronic document are linked to each other.

In selected embodiments, the user-selectable input control provides that the new electronic document is a follow-up of the selected electronic document.

Advantages of the systems and techniques described herein may include any or all of the following. Creation of documents related to each other can be made more efficient. Document management and organization can be made more efficient and easier to handle for a user. A graphical user interface can be made more user-friendly. User navigation between related documents can be made more convenient and efficient.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1A-D are examples of operations that can be performed in an embodiment of an inventive graphical user interface;

FIG. 2 is a flow chart of a method according to the present invention; and

FIG. 3 is a block diagram of a computer system that can generate the graphical user interface shown in FIGS. 1A-D.

Like reference numerals in the various drawings indicate like elements.

### DETAILED DESCRIPTION

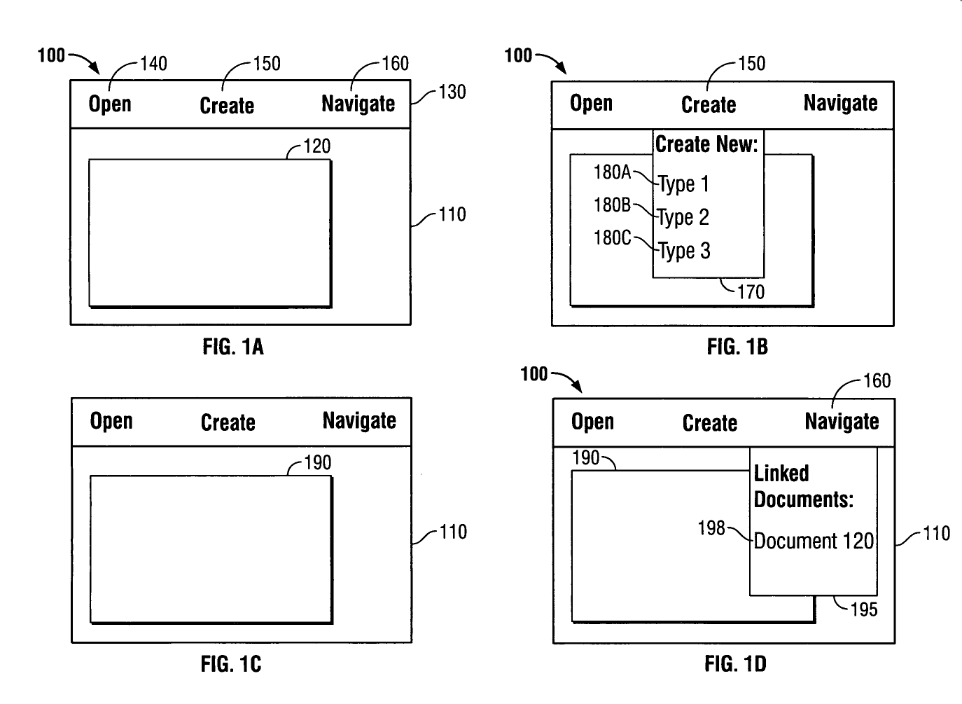

FIG. 1A shows a graphical user interface (GUI) 100 that can be generated by a computer system. As will be described below, the GUI 100 can be used for creating, and navigating between, electronic documents that are linked to each other. The GUI 100 includes a document display area 110 in which a view of an exemplary electronic document 120 is currently being displayed. The GUI 100 comprises a toolbar 130 which may include one or more input controls by which a user can perform actions in the computer system, for example with regard to a document displayed in the document display area 110. In this example, the GUI 100 includes an Open input control 140, a Create input control 150, and a Navigate input control 160. The Open input control 140 lets the user open an existing document in the document display area 110. That is, the user may choose to have a view of the document 120 displayed by first activating the Open input control 140 and then selecting the document 120 from a list of available documents.

The following is an exemplary scenario in which the GUI 100 may be used. The document 120 may be an activity record that contains information for a sales representative's meeting with a customer. The activity record 120 may include information about the customer, a recent sales order received from the customer, and other facts that are relevant to the specific visit. The sales representative can refer to the activity record 120 prior to, or even during, the meeting, for example if the GUI 100 is displayed on a portable computer device such as a laptop computer or a handheld device. During the meeting, the representative may learn of an additional sales opportunity with regard to this particular customer. To make sure that such opportunities are not forgotten, the representative may wish to create an opportunity record memorializing the specific information. Because the opportunity was discovered during the customer meeting, there is a relation between the opportunity record and the activity record.

The user may therefore select the Create input control 150 (for example using the pointing device). The Create input control 150 lets the user create a new electronic document that is linked to the currently displayed document 120. For example, the Create input control 150 may include a menu 170 that appears in the GUI 100 as shown in FIG. 1B. Here, the menu 170 lets the user choose between three different types of new document that can be created. That is, the user can select any of input commands 180A, 180B or 180C to create a new electronic document of the type represented by the selected command. When the user selects one of the commands 180A-C, the computer system receives a predetermined user input that is associated with the selected command and may use that input in creating, and subsequently displaying a view of, the new electronic document. The different document types may refer to different document formatting or documents of different file types. For example, one of the document types may be a document that is a follow-up of the displayed document. In this example, the user selects the command 180A to create a new electronic document of “Type 1”. FIG. 1C shows the new electronic document 190 displayed in the document display area 110. The new document 190 and the document 120 are linked to each other, and this linking, for example, can be used for convenient navigation. When created, the new document 190 may replace the currently displayed document 120 in the GUI 100. That is, the currently displayed document 120 may cease to be displayed upon creation of the new document. Alternatively, the document 120 may remain in the document display area 110 after the new document 190 is created.

FIG. 1D shows the GUI 100 at a time when only the view of the electronic document 190 is being displayed in the document display area 110. For example, this situation may occur when the document 190 is created if the document 120 disappears upon its creation, or it may take place at a later time when the user has chosen to open the document 190 in the GUI 100 (for example, using the Open input control 140). While reviewing the document 190 (for example an opportunity record), the user may be interested in seeing what documents the currently displayed document is linked to. The user may therefore select the Navigate input control 160 to trigger the display of a menu 195 in the GUI 100. The menu 195 identifies the document(s) to which the currently displayed document 190 is linked. In this example, the menu includes a command 198 that the user can select to display the view of the document 120 in the document display area 110. If the user selects the command 198 in the FIG. 1D situation, the GUI 100 may again appear as it did in FIG. 1A.

In other implementations, more or fewer user selectable commands than the three commands 180A-C may be presented in the menu 170. The Create input control 150 may provide that the user can create any kind of document that can be handled and stored in the particular computer system. Accordingly, the menu 170 may include a separate user selectable command for each type of electronic document that the user is able to create. For example, one or more of the commands 180A-C may create a document of the same type as the currently displayed document 120. One or more of the commands 180A-C may create a document of a different type than the currently displayed document, such as a document that is handled by a different application program.

In addition to the function described above, the Create input control 150 may provide that the user can create a new electronic document that is not linked to the document displayed in document display area 110 or any document in the computer system. Such document creation may function similarly to that available in many existing software applications. One advantage of such implementations is that the user can simply choose between creating a linked or non-linked document.

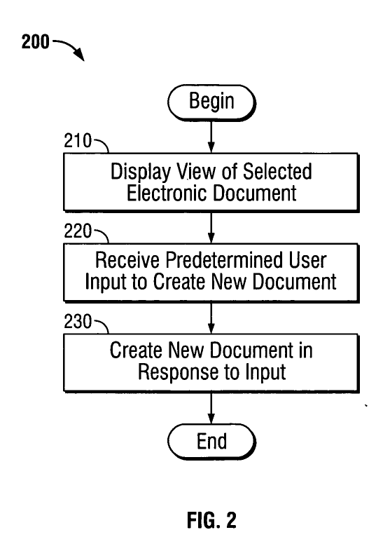

FIG. 2 is a flow chart of a method 200 of creating an electronic document that is linked to another electronic document. Preferably, the method 200 is performed in a computer system. For example, a computer program product can include instructions that cause a processor to perform the steps of the method 200. The method 200 includes the following steps:

Displaying, in step 210, a view of a selected electronic document on a graphical user interface. For example, the user may select the electronic document 120 to be displayed on the GUI 100 as was described above with reference to FIG. 1A.

Receiving, in step 220, a predetermined user input to create a new electronic document. The predetermined user input is received while the view of the selected electronic document is being displayed. For example, the predetermined user input may be generated with the Create input control 150. Particularly, the user input may be received upon user selection of one of the commands 180A-C.

Creating, in step 230, the new electronic document in response to receiving the predetermined user input. The selected electronic document and the new electronic document are linked to each other. For example, the new electronic document 190 is created in response to receiving the input of the user's selection of the command 180A. The document 190 and the document 120 are linked to each other, such that when the document 190 is being displayed, the Navigate input control 160 identifies, and provides convenient access to, the document 120.

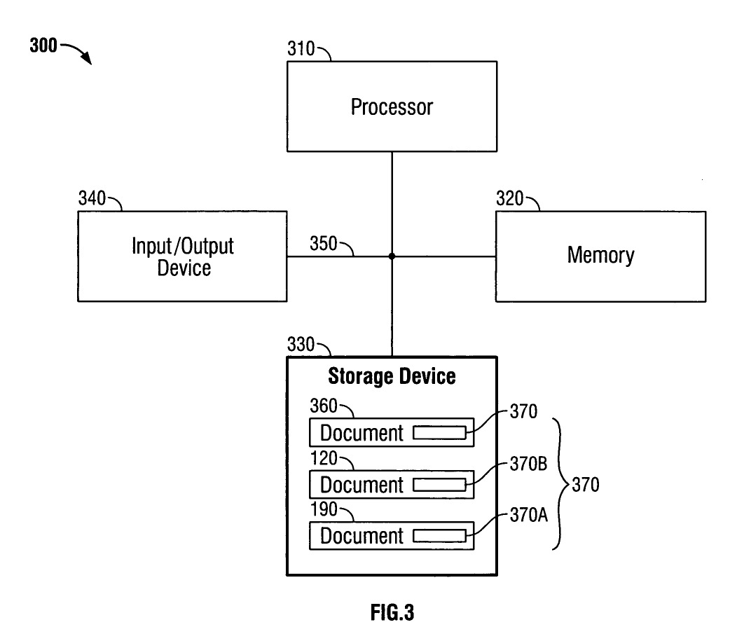

FIG. 3 is a block diagram of a computer system 300 that can be used in the operations described above, according to one embodiment. The system 300 includes a processor 310, a memory 320, a storage device 330 and an input/output device 340. Each of the components 310, 320, 330 and 340 are interconnected using a system bus 350. The processor 310 is capable of processing instructions for execution within the system 300. In one embodiment, the processor 310 is a single-threaded processor. In another embodiment, the processor 310 is a multi-threaded processor. The processor 310 is capable of processing instructions stored in the memory 320 or on the storage device 330 to display graphical information for a user interface on the input/output device 340.

The memory 320 stores information within the system 300. In one embodiment, the memory 320 is a computer-readable medium. In one embodiment, the memory 320 is a volatile memory unit. In another embodiment, the memory 320 is a non-volatile memory unit.

The storage device 330 is capable of providing mass storage for the system 300. In one embodiment, the storage device 330 is a computer-readable medium. In various different embodiments, the storage device 330 may be a floppy disk device, a hard disk device, an optical disk device, or a tape device.

The input/output device 340 provides input/output operations for the system 300. In one embodiment, the input/output device 340 includes a keyboard and/or pointing device. In one embodiment, the input/output device 340 includes a display unit for displaying graphical user interfaces as discussed above with reference to FIGS. 1A-D.

FIG. 3 shows the documents 120 and 190 stored in the storage device 330. As was mentioned in the example above, the document 190 may be an opportunity record that is created as a follow-up of document 120 which may be an activity record. The activity record, in turn, may have been created as a follow-up of a document 360 in storage device 330, such as a sales order from the particular customer to which the activity record relates. That is, the activity record 120 is linked to the sales order 360 and may have been created while it was being displayed in GUI 100. The opportunity record 190 is linked to the activity record 120 and may have been created while that document was being displayed in document display area 110.

The linking between documents in system 300 may be provided using one or more identifiers 370 stored in association with the documents. For example, upon creation of the new electronic document 190, a first identifier 370A may be stored in association with the document 190. When the system receives the input to create the new document, it may first determine what document is currently being displayed in the graphical user interface. Based on that determination, it may create the identifier 370A to be stored in association with the new document. The first identifier 370A indicates that the document 190 and the document 120 are linked to each other. When the document 190 is being displayed, the identifier 370A can be used in determining the document to which the currently displayed document is linked.

In some implementations, a second identifier 370B is stored in association with the document 120 upon creation of the document 190. The second identifier 370B identifies the document 190 as being linked to the document 120. When the activity record 120 is displayed, identifier 370A can be used in identifying the opportunity record 190 as a linked document. Accordingly, identifiers may be stored in association with both the currently displayed document and the new document.

Upon creation of the document 120, a third identifier 370C may be stored in association with the document 360, similarly to the first identifier 370A being stored in association with the document 120.

A user may wish to create more than one new document that is linked to an existing document. For example, if a document containing notes from a meeting is currently being displayed, a user may wish to create several follow-up reminders regarding issues that came up in the meeting. The user may create the several new follow-up documents while the initial document (the notes from the meeting) is being displayed. In such an example, several identifiers may be stored in association with the initial document, reflecting the several follow-up documents that have been created.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of creating an electronic document that is linked to another electronic document, the method comprising:
displaying a view of a selected electronic document on a graphical user interface;
receiving, while the view of the selected electronic document is being displayed, a predetermined user input to create a new electronic document; and
creating the new electronic document in response to receiving the predetermined user input, wherein the selected electronic document and the new electronic document are linked to each other.

2. The method of claim 1, further comprising providing that a user can make any of a plurality of predetermined user inputs, each of the predetermined user inputs causing a specific new electronic document to be created.

3. The method of claim 1, wherein the predetermined user input is made by selection of a user-selectable command in a menu of the graphical user interface, and wherein the menu further includes another user-selectable command for creating an electronic document that is not linked to the selected electronic document.

4. The method of claim 1, wherein the predetermined user input specifies that the new electronic document is a follow-up of the selected electronic document.

5. The method of claim 1, further comprising storing an identifier in association with at least one of the selected electronic document and the new electronic document to link them to each other.

6. The method of claim 5, further comprising using the identifier, while a view of the new electronic document is being displayed, to provide access to the selected electronic document.

7. The method of claim 5, further comprising using the identifier, while the view of the selected electronic document is being displayed, to provide access to the new electronic document.

8. The method of claim 5, further comprising:
making a determination, in response to receiving the predetermined user input, that the view of the selected electronic document is being displayed; and
generating the identifier based on the determination.

9. The method of claim 5, wherein a first identifier is stored in association with the selected electronic document and a second identifier is stored in association with the new electronic document to link them to each other.

10. The method of claim 9, wherein the selected electronic document is also linked to at least one other electronic document and wherein a third identifier is stored in association with the selected electronic document to link them to each other.

11. The method of claim 10, wherein the selected electronic document is a follow-up of the at least one other electronic document.

12. A computer program product tangibly embodied in an information carrier, the computer program product including instructions that, when executed, cause a processor to perform operations comprising:
display a view of a selected electronic document on a graphical user interface;
receive, while the view of the selected electronic document is being displayed, a predetermined user input to create a new electronic document; and
create the new electronic document in response to receiving the predetermined user input, wherein the selected electronic document and the new electronic document are linked to each other.

13. The computer program product of claim 12, wherein the operations further comprise:
store an identifier in association with at least one of the selected electronic document and the new electronic document to link them to each other.

14. The computer program product of claim 13, wherein the operations further comprise:
use the identifier, while a view of the new electronic document is being displayed, to provide access to the selected electronic document.

15. The computer program product of claim 13, wherein the operations further comprise:
use the identifier, while the view of the selected electronic document is being displayed, to provide access to the new electronic document.

16. A computer program product tangibly embodied in an information carrier, the computer program product including instructions that, when executed, generate on a display device a graphical user interface for creating an electronic document that is linked to another electronic document, the graphical user interface comprising:
a document display area wherein a view of a selected electronic document can be displayed; and
a user-selectable input control that creates a new electronic document while the view of the selected electronic document is being displayed, wherein the selected electronic document and the new electronic document are linked to each other.

17. The computer program product of claim 16, wherein the graphical user interface further comprises a plurality of user-selectable input controls, each of which creates a specific new electronic document.

18. The computer program product of claim 16, wherein the graphical user interface further comprises a menu that includes the user-selectable input control and another user-selectable input control for creating an electronic document that is not linked to the selected electronic document.

19. The computer program product of claim 16, wherein the user-selectable input control provides that the new electronic document is a follow-up of the selected electronic document.
